(19) United States
(12) Patent Application Publication
(10) Pub. No.: US 2008/0066350 A1
(43) Pub. Date: Mar. 20, 2008

(54) Method and Apparatus for Excavation of a Trench

(76) Inventors: Robert George Humphries, Herts (GB); Stuart P. Norman, London (GB)

Correspondence Address: DYKEMA GOSSETT PLLC, 39577 WOODWARD AVENUE, SUITE 300, BLOOMFIELD HILLS, MI, 48304-5086, US

(21) Appl. No.: 11/574,866

(22) PCT Filed: Aug. 18, 2005
(86) PCT No.: PCT/GB05/03251

§ 371 Date: Aug. 29, 2007

(30) Foreign Application Priority Data
Sep. 9, 2004 (GB) 0420065.5

(51) Int. Cl. G05D 1/00; E02F 1/00; E02F 5/02

(52) U.S. Cl. 37/348; 37/195; 701/50

(57) ABSTRACT

The present application relates to a method and apparatus for excavating soil from the ground to form a hole or trench. The tool is provided with a plurality of excavation members which are caused to penetrate the ground in order that soil may be excavated. The direction of excavation of the tool may be adjusted by the use of one or more steering members (10), the or each steering member comprising a steering element (11) which is disposed, or is operable to be disposed, such that the initial point of contact of the steering element with the ground allows the direction of excavation of the tool to be adjusted. Provides a simple, but effective, mechanical means to adjust the direction of excavation. The steering element may comprise a plate which is angled such that at the point of contact with the ground, the steering members may gently divert the grab in the desired direction. Thus, in this way, any deviation in the direction of excavation can be corrected or at least countered. Furthermore, the direction of excavation of the tool may be monitored which may involve monitoring the plan position of the tool and/ or the verticality of the tool as it penetrates the ground.

The present invention relates generally to the construction of foundation elements, and, more particularly, to the construction of diaphragm walls or barrettes. More specifically, the present invention relates to a method and apparatus for adjusting the direction of excavation of an excavation tool. This tool is particularly, but not exclusively, applicable for the excavation of a trench to facilitate the construction of one or more diaphragm wall panels.

Diaphragm walls are generally constructed in a series of discrete sections. Firstly, a narrow trench of appropriate dimensions is excavated in the ground using a excavation tool, commonly known in the art as a “grab”. Subsequently, one or more concrete panels are formed in the trench, using pre-cast or cast-in-situ techniques, to form a diaphragm wall or barrette comprising a series of concrete panels.

Several types of grab are known. Typical are (wire) rope-suspended grabs which can be operated mechanically or hydraulically. Other types of grabs include hydraulically actuated grabs attached to Kelly bars or the like, and grabs which rely on a combination of short Kelly bars and rope suspension.

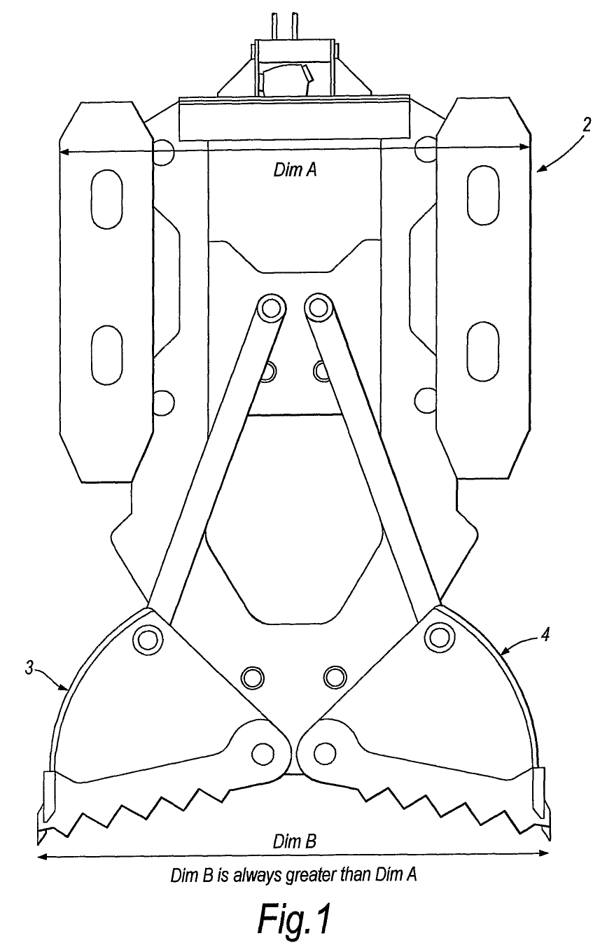

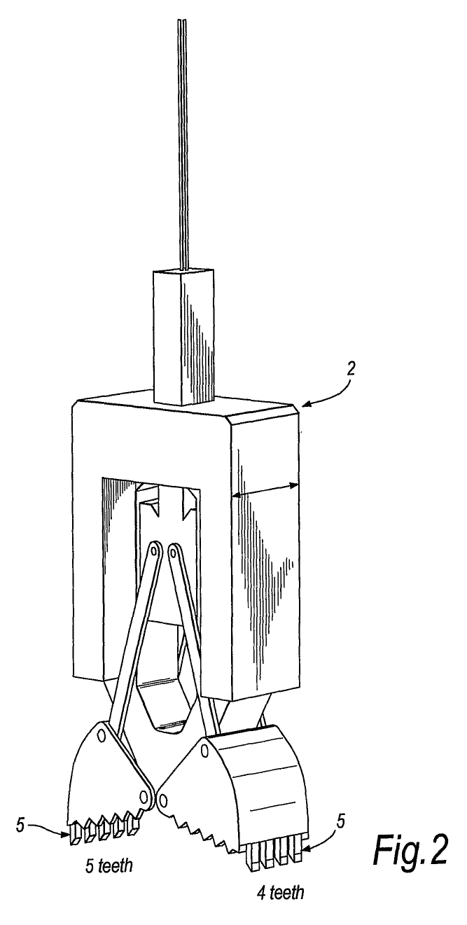

FIGS. 1 and 2 show a conventional grab, generally designated 2, employed during the formation of a diaphragm wall to excavate a trench. The required trench is frequently longer in plan than the plan “footprint” of the grab and it is therefore usual for the trench to be excavated in two or more discrete “bites”. As shown in FIGS. 1 and 2, the previously proposed grabs comprise two opposed jaws, 3 and 4, each jaw being provided with a plurality of excavation members or “teeth” 5. It is usual for the number of teeth on each jaw to be unequal; one of the jaws having one tooth more than the other so that in a closed position the teeth on one jaw mesh with the teeth on the opposing jaw.

During excavation, the grab is lowered to the ground or the base of the bore with the jaws disposed in an open position so that the teeth point substantially vertically downwards. Thus, as the grab is lowered, the teeth are caused to penetrate the underlying soil. The jaws are then operable to be moved to a closed position thereby trapping the excavated soil within the mouth of the grab. The grab is hoisted to above ground level, the jaws opened to discharge the excavated soil and the cycle repeated as necessary. The excavation therefore proceeds in an incremental fashion until the required depth has been achieved.

The body of the grab contains the mechanism which facilitates the movement of the jaws between a fully open and a fully closed position. The body is also provided with longitudinal guides which extend substantially vertically downwards when the grab is in use. These guides serve to assist with maintaining the verticality of the grab during the excavation process. When viewed in plan from above, it can be seen that the footprint of the guides is smaller than the footprint of the open jaws. Thus, in FIG. 1, length A is less than length B. This clearance is necessary to ensure that the guides do not hinder the movement of the grab in the excavated trench. In particular, without this clearance, the guides may hinder or even prevent the grab from being lowered or raised in the trench.

A common problem with the previously considered grabs is that deviations can occur in the direction of excavation of the grab. This is a particular problem in areas where there are variable ground conditions where variations in the hardness of the strata can make it difficult to control the downward movement of the grab. Deviations occur due to changes in the verticality of the excavation tool, deviations in the plan orientation of the tool in an x- or y-direction, or due to twisting of the tool. The deviation may be gradual as the grab proceeds to a greater and greater depth.

Any deviations in the direction of excavation can lead to the formation of concrete panels which, in the worst case, may exceed any plan positional tolerances which may, for example, be imposed under contract, or which arise due to practical limitations, for example, relating to the proposed structure to be formed within the diaphragm wall enclosure. The consequences of deviations arising in the direction of excavation can be very expensive and may even result in a lengthy re-design of the planned structure and/or the need to re-construct one or more of the panels. This obviously adds significantly to the overall cost of the construction and also delays completion of the work. Furthermore, excessive deviations may also result in inadequate concrete cover of the reinforcing cage of the panel and/or difficulties in installing/removing stopend shutters.

In some instances it may be desirable, or even a contractual requirement, to reduce the plan positional tolerances (N-S & E-W) to 1% of the depth of excavation. Thus, for example, the construction of a 40 m deep panel allows a deviation of only 400 mm which can be difficult to achieve with presently known methods.

One previously proposed method relating to hydraulic grabs involves the use of thrust plates incorporated into the longitudinal guides. These thrust plates may be (hydraulically) operated against the side of the bore in order to correct any deviations as they occur. However, grabs which incorporate the use of hydraulic thrust plates are comparatively expensive. Moreover, the use of thrust plates in this way to correct deviations cannot be easily applied to mechanical grabs.

Thus, there is a need to provide a means for controlling and/or adjusting the direction of excavation of an excavation tool.

According to one aspect of the present invention, there is provided a method of excavating soil from the ground to form a hole or trench, the method comprising the steps of: i) applying to the ground an excavation tool having a plurality of excavation members; and ii) causing the plurality of excavation members to penetrate the ground in order that soil may be excavated, wherein the direction of excavation of the tool may be adjusted by the use of one or more steering members, the or each steering member comprising a steering element which is disposed, or is operable to be disposed, such that the initial point of contact of the steering element with the ground allows the direction of excavation of the tool to be adjusted.

In the context of the present invention, “soil” should be interpreted generally to include any ground material or strata.

An advantage of the present invention is that the use of one or more steering members provides a simple, but effective, mechanical means to adjust the direction of excavation. The steering element preferably comprises a plate which is angled such that at the point of contact with the ground, the steering members may gently divert the grab in the desired direction. Thus, in this way, any deviation in the direction of excavation can be corrected or at least countered.

Preferably the method further comprises the step of monitoring the direction of excavation of the tool which may involve monitoring the plan position of the tool and/ or the verticality of the tool as it penetrates the ground. The direction of excavation of the tool may be monitored using a means to measure the inclination of the tool in at least one direction. Preferably however, the direction of excavation of the tool is monitored using a means to measure the inclination of the tool in two mutually orthogonal directions.

In preferred embodiment the means to measure the inclination of the tool comprises one or more electrolevel inclinometers. Inclinometers (which are known per se) generally employ a plurality of orientation sensors and are particularly advantageous since they allow for the positional information to be monitored continuously, in real-time, by a data logger. They are therefore particularly useful when used in conjunction with the steering members employed by embodiments of the present invention to provide instant data feedback to the operator. Thus, an operator can detect any relatively minor changes in the orientation of the grab and can deploy one or more steering members in an appropriate fashion in order to correct, or at least counter, the deviation. Systems implementing the present invention preferably integrate, at regular depth intervals such as 50 mm, the inclination over the depth interval to calculate the new plan position of the grab. The systems may preferably show deviation in real time rather than being measured against time.

In one embodiment, the or each steering member must be attached to the tool in order to facilitate the adjustment of the direction of excavation of the grab, in the event that deviation is observed. Thus, a method embodying the present invention may further comprise the steps of: iii) lifting the tool from the ground; iv) exchanging one or more of the excavation members with one or more steering members; and v) reapplying the tool to the ground until the required adjustment in the direction of excavation has been achieved. Furthermore, the method may additionally comprise the steps of vi) lifting the tool again from the ground; exchanging one or all of the or each of the steering members with one or more other steering members, or with one or more excavation members.

Alternatively, it is envisaged that one or more steering members may be coupled to the tool without the need to remove the conventional excavation members.

In another embodiment, the steering member may be provided on the tool and may be deployable in order to adjust the direction of excavation of the tool. In this regard, it is envisaged that one or more of the excavation members is provided with a deployable steering element.

According to a second aspect of the present invention there is provided an apparatus for excavating soil from the ground to form a hole or trench, the apparatus comprising a tool having a plurality of excavation members, wherein one or more of the excavation members is provided with a steering element which is disposed, or is operable to be disposed, such that, in use, the initial point of contact of the steering element with the ground allows the direction of excavation of the tool to be adjusted.

Preferably, the steering element extends from, or relative to, the excavation member. It may be of fixed orientation relative to the excavation member or it may be operable to be moved relative to the excavation member in order to be deployed for use.

According to a third aspect of the present invention there is a steering element which is suitable for use with the method of the first aspect.

According to a fourth aspect of the present invention, there is provided a steering element which is suitable for use with the apparatus of the second aspect.

According to a fifth aspect of the present invention, there is provided an excavation member for a ground excavation tool, the excavation member comprising a steering element which is disposed, or is operable to be disposed, such that when provided on the tool in use, the initial point of contact of the steering element with the ground allows the direction of excavation of the tool to be adjusted.

Features embodying one aspect of the present invention may be applied to any other aspect.

For a better understanding of the present invention, and to show how the same may be carried into effect, reference will now be made, by way of example, to the accompanying drawings in which:

FIGS. 1 and 2 show a excavation tool according to the prior art; and

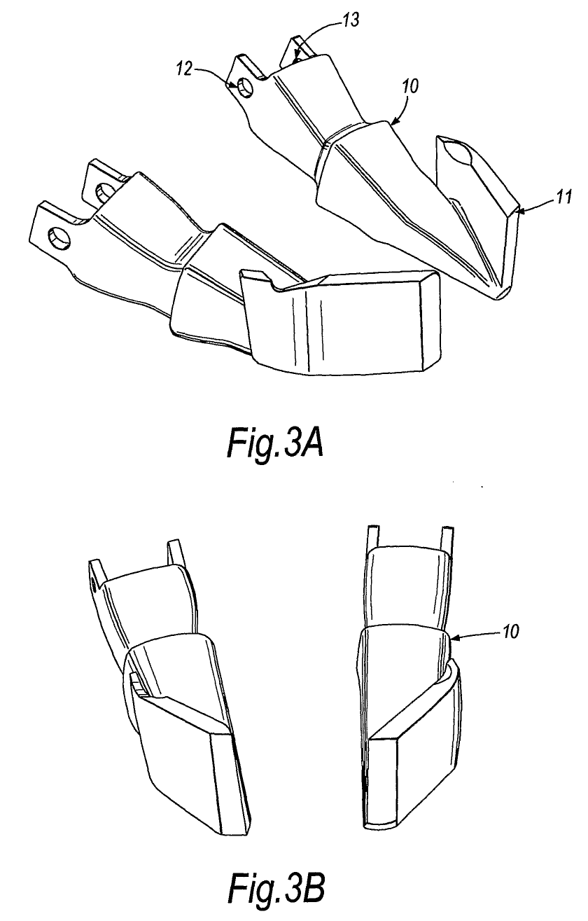

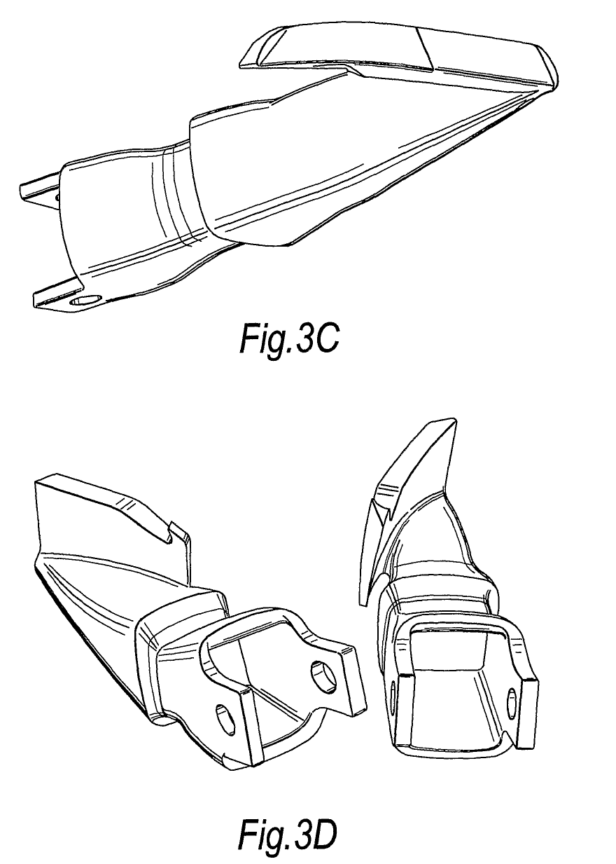

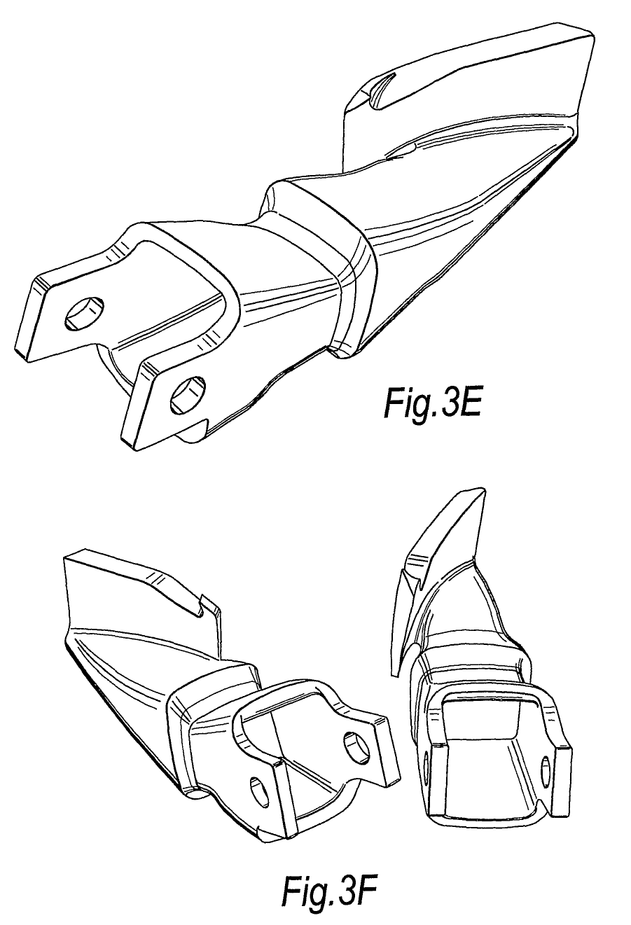

FIGS. 3A to 3F show various photographs of steering members embodying the present invention.

FIGS. 3A to 3F show, from various angles, a steering member 10 suitable for attachment to a grab for excavating ground material. The steering member comprises an excavation tooth having a steering element 11 in the form of an angled plate rigidly connected to the excavation tooth.

In use, when connected at connection points 12 and 13 to a grab, the steering member is caused to penetrate the ground. The angled plate is disposed such that as the tooth penetrates the ground, the grab is gently steered as a result of the forces arising from ground contact with the angled plate, to cause an adjustment in the excavation direction of the grab.

1. A method of excavating soil from the ground to form a hole or trench, the method comprising the steps of: i) applying to the ground an excavation tool, the tool comprising two jaws, each jaw having a plurality of excavation members projecting therefrom, the jaws being operable to be moved between an open position, in which the excavation members are operable to penetrate the ground, and a closed position, in which the excavation members on one said jaw mesh with the excavation members provided on the other said jaw; and ii) operating the tool in order to move the jaw between said open position to said closed position in order to excavate soil from the ground, wherein one or more of the excavation members is provided with a steering element which is disposed, or is operable to be disposed, such that the initial point of contact of the steering element with the ground allows the direction of excavation of the tool to be adjusted.

2. A method as claimed in claim 1, further comprising the step of monitoring the direction of excavation of the tool.

3. A method as claimed in claim 2, wherein the step of monitoring the direction of excavation of the tool comprises the step of monitoring the plan position of the tool and/or the verticality of the tool as it penetrates the ground.

4. A method as claimed in claim 1, wherein the direction of excavation of the tool is monitored using a means to measure the inclination of the tool in at least one direction.

5. A method as claimed in claim 4, wherein the direction of excavation of the tool is monitored using a means to measure the inclination of the tool in two mutually orthogonal directions.

6. A method as claimed in claim 4, wherein the means to measure the inclination of the tool comprises one or more electrolevel inclinometers.

7. A method as claimed in claim 6, wherein the or each electrolevel inclinometer is connected to a data logging means.

8. A method as claimed in claim 1, wherein the direction of excavation of the tool is adjusted in response to detecting a deviation in the plan position and/or verticality of the tool.

9. A method as claimed in claim 1, further comprising the steps of:
iii) lifting the tool from the ground; iv) exchanging one or more of the excavation members with an excavation member having a steering element; and v) reapplying the tool to the ground until the required adjustment in the direction of excavation has been achieved.

10. (canceled)

11. A method as claimed in claim 1, wherein the steering element extends from, or relative to, the excavation member.

12. A method as claimed in claim 1, wherein the r each steering element is of fixed orientation relative to the excavation member.

13. A method as claimed in claim 1, wherein the steering element is operable to be moved relative to the excavation member.

14. A ground excavation tool for excavating soil from the ground to form a hole or trench, the tool comprising two jaws, each jaw having a plurality of excavation members projecting therefrom, the jaws being operable to be moved between an open position, in which the excavation members are operable to penetrate the ground, and a closed position, in which the excavation members on one said jaw mesh with the excavation members provided on the other said jaw, wherein one or more of the excavation members is provided with a steering element which is disposed, or is operable to be disposed, such that, in use, the initial point of contact of the steering element with the ground allows the direction of excavation of the tool to be adjusted.

15. A tool as claimed in claim 14, further comprising means to monitor the direction of excavation of the tool.

16. A tool as claimed in claim 15, wherein the means to measure the direction of excavation of the tool comprises a means to measure the inclination of the tool in at least one direction.

17. A tool as claimed in claim 15, wherein the means to measure the direction of excavation of the tool comprises a means to measure the inclination of the tool in two mutually orthogonal directions.

18. A tool as claimed in claim 16, wherein the means to measure the inclination of the tool comprises one or more electrolevel inclinometers.

19. A tool as claimed in claim 18, further comprising a data logging means connected to the or each electrolevel inclinometer.

20. An excavation member comprising a steering element for use in the method of claim 1.

21. An excavation member comprising a steering element for use with the apparatus of claim 14.

22. An excavation member for a ground excavation tool, the excavation member comprising a main body and a steering element and being provided with means for connection to said ground excavation tool, wherein said steering element is disposed, or is operable to be disposed, relative to the main body such that, the initial point of contact of the steering element with the ground when the excavation member is caused to penetrate the ground, allows the direction of excavation of said excavation member to be adjusted.
